(19) United States
(12) Patent Application Publication
(10) Pub. No.: US 2009/0211536 A1
(43) Pub. Date: Aug. 27, 2009

(54) Carrier device for saddles

(76) Inventor: Lisa A. Phipps, New Enterprise, PA (US)

Correspondence Address: LITMAN LAW OFFICES, LTD., POST OFFICE BOX 15035, CRYSTAL CITY STATION, ARLINGTON, VA, 22215-0035, US

(21) Appl. No.: 12/071,879

(22) Filed: Feb. 27, 2008

(51) Int. Cl. B68B 1/00; A01K 1/035

(52) U.S. Cl. 119/496; 54/44.1

(57) ABSTRACT

The carrier device for saddles is a device intended for mounting behind a saddle and provides a way for a horseback rider to carry a dog or other items that might not be suitable for a traditional saddlebag or backpack. The carrier device for saddles may be made from flex tree material, and has four vertical sides and an open top. Holes in the front and rear walls of the device are sized to accommodate the head and legs of a dog. A harness is provided inside the device that secures a dog in a prone position on the back of a horse. The device attaches to the saddle girth. Two inserts are provided that can accommodate different sizes of dogs, or to allow other items to be carried when a dog is not aboard.

### BACKGROUND OF THE INVENTION

1. Field of the Invention

The present invention relates to carrier devices, and more particularly to a carrier device attached to the back of a trail saddle for carrying pets or small items while horseback riding.

2. Description of the Related Art

Horseback riding is well known. There is evidence suggesting that horses were first ridden approximately 4500 B.C. In ancient times, chariot warfare was followed by the use of warhorses as light and heavy cavalry. The horse played an important role throughout human history all over the world, both in warfare and in peaceful pursuits such as transportation, trade and agriculture.

Horseback riding is an important recreational and therapeutic activity. There are historical references explaining the various therapeutic benefits of horsemanship that date from 600 B.C. In the late nineteenth century, physicians were prescribing horseback riding for patients with joint pain, neurological, mobility and balance issues. Oxford Hospital in England suggested riding therapy for soldiers injured in World War I. There is a large body of medical research that suggests that horseback riding may greatly benefit people with special needs. This knowledge has grown and has been applied in various ways.

The most obvious and often the most immediately recognizable benefit is physical. By its very nature, horse riding influences the whole person and the effect on all of the body's systems can be quite profound. The movement of the horse in combination with the rider has extraordinary effects on the systems of the human body.

The movement of the horse keeps the rider continuously off balance. This requires the rider's muscles to continually contract and relax in an attempt to re-balance. This continual movement works the deep core muscles of the trunk and pelvis, and the adductor muscles of the thigh. Other muscles are also involved based on the speed of the horse.

Riding develops balance and coordination. Repetition of the pattern movements required to control the horse aid to quicken the reflexes.

Horse riding also has cardiovascular benefits. The total calories burned by a rider when trotting or cantering are very similar to the amount of calories burned while cycling or jogging and range from 315 to 480 calories per hour. Riding a horse at walk also stimulates the internal organs just as walking on foot does. Liver function and digestion are enhanced, thus horse riding is often recommended for people with mobility issues or people in wheelchairs. The health benefits of horseback riding are so well documented that artificial exercise machines that mimic the motion of a horse have been developed.

In the United States, recreational riding evolved mainly from the western riding tradition. Western riding evolved from the cattle working and warfare traditions brought to the Americas by the Spanish conquistadores, and both equipment and riding style evolved to meet the needs of the working cowboy on ranches in the American West.

The most prominent feature of western style riding is the saddle. Western saddles feature a prominent pommel topped by a horn, a deep seat and a high cantle. The saddle generally features wide stirrups and multiple rings and ties whereby objects may be attached to the saddle

Western saddles generally have a substantial tree that provides support for both animal and rider when working long hours in the saddle. The western saddle tree is traditionally made from wood. Because of their flexibility, usually softer woods such as Ponderosa Pine, Beechwood, Ash, Cottonwood and Douglas Fir are chosen. Once the tree is assembled, a wet covering is stretched over the tree and allowed to dry and shrink. Traditionally a rawhide covering is used. Once the covering is dry, a coat of varnish is applied to seal the material. The result is a very strong saddletree that retains an element of flexibility.

Because most riding is done for recreation, the largest groups of saddles in use are recreational or trail saddles. Trail saddles can be similar in appearance to western or working saddles, but they are generally much lighter and have less ornamentation and accessories than a traditional western saddle. Often they are manufactured from synthetic, flex-tree material, rather than the traditional wooden saddletrees.

Since trail saddles may be smaller and lighter than working, western style saddles, they may not have rings and ties so that items can be attached. Additionally, recreational riders might desire to have their dogs accompany them on their rides. There is a need for a carrier device for saddles that can accommodate a dog on a ride and also carry items that may not be suitable for a traditional saddlebag or a backpack. Thus, a carrier device for saddles solving the aforementioned problems is desired.

### SUMMARY OF THE INVENTION

The carrier device for saddles is a device intended for mounting behind a saddle and provides a way for a horseback rider to carry a dog or other items that might not be suitable for a traditional saddlebag or backpack. The carrier device for saddles may be made from flex tree material, and has four vertical sides, a bottom wall, and an open top. Holes in the front and rear walls of the device are sized to accommodate the head and legs of a dog. A harness is provided inside the device that secures a dog in a prone position on the back of a horse. The bottom wall of the carrier device for saddles is contoured to fit across the back of a horse. The harness can also be adapted to secure a dog in an upright-seated position behind the rider. The device has two connecting straps that attach to the saddle girth.

Two inserts are provided, which may be made of a rigid polyfoam material. The first insert slides completely into the carrier device and is sized for smaller dogs. The second insert slides completely into the first insert and can accommodate other items, such as beverage containers or food items, when a dog is not aboard. The open top has an attachable lid, and provides easy access to the interior of the carrier device. While primarily intended for use in recreational horseback riding, the carrier device for saddles could be adapted for securely carrying a dog on the back of a motorcycle or off road recreational vehicle.

These and other features of the present invention will become readily apparent upon further review of the following specification and drawings.

### BRIEF DESCRIPTION OF THE DRAWINGS

FIG. 1 is an environmental, perspective view of a carrier device for saddles according to the present invention.

FIG. 2 is an environmental top view of a carrier device for saddles according to the present invention.

FIG. 3 is an environmental, perspective view of a carrier device for saddles according to the present invention, showing alternative inserts and an attachable lid exploded from the carrier device.

FIG. 4 is an environmental, perspective view of a carrier device for saddles according to the present invention, shown configured for a reclining dog.

FIG. 5 is an environmental, perspective view of a carrier device for saddles according to the present invention, shown configured for a seated dog.

Similar reference characters denote corresponding features consistently throughout the attached drawings.

### DETAILED DESCRIPTION OF THE PREFERRED EMBODIMENTS

The present invention relates generally to carrier devices, and more particularly, to a carrier device for saddles that attaches to a saddle and enables a rider to convey a pet dog or other items when horseback riding.

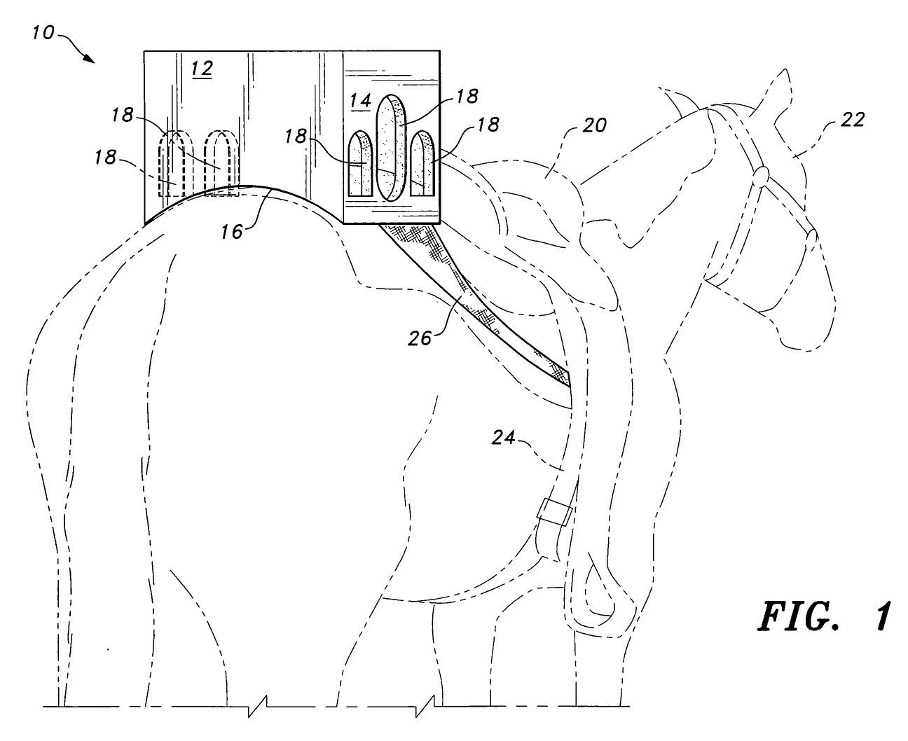

The carrier device for saddles, generally designated as 10, is shown in FIG. 1 in position behind the saddle 20. The horse 22 and saddle 20 are shown in phantom. FIG. 1 shows the carrier device for saddles 10 having opposing vertical sidewalls 12, a rear wall, a front wall 14, and a bottom wall 16, defining a rectangular box with an open top. The front wall 14 has ports 18 sized to fit the head and legs of a medium to large-sized dog, the rear wall being a mirror image of the front wall 14, although the port for the dog's head may be omitted from the rear wall. The carrier device 10 has connector straps 26 extending from the bottom wall of the box that attach to the saddle girth 24, shown in phantom. The bottom wall 16 of the carrier device 10 has an arched configuration to fit securely on the back of a horse 22. The carrier device for saddles 10 may be constructed of saddletree material.

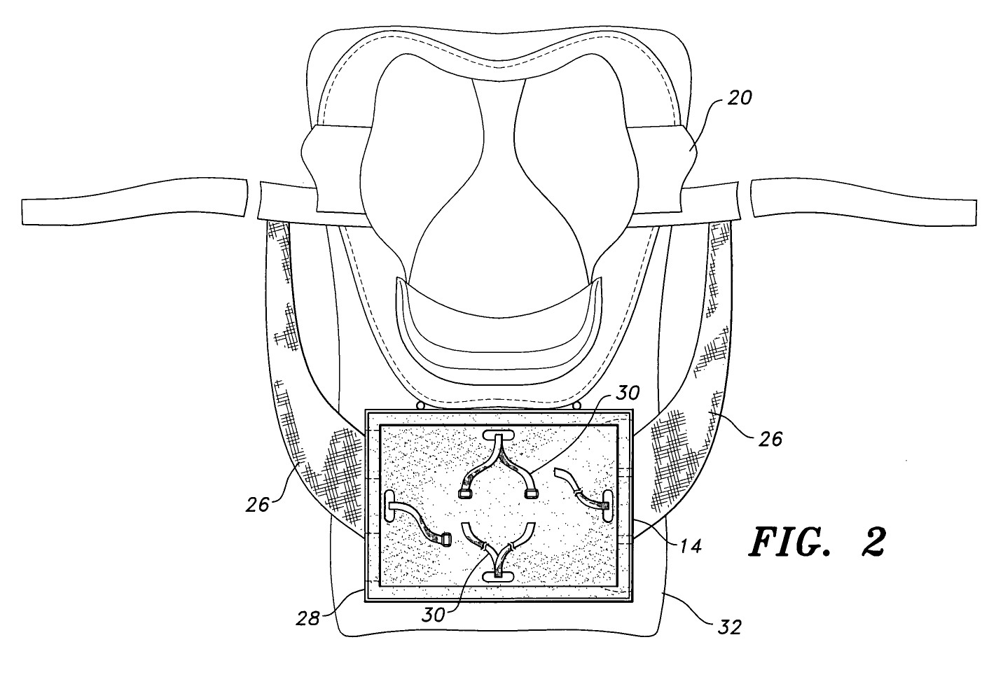

FIG. 2 is a top view of the carrier device for saddles 10 in position behind the saddle 20. The carrier device for saddles 10 is secured by the connecting straps 26 and sits on the saddle blanket 32. There is a harness 30 attached to the interior for securely holding a dog.

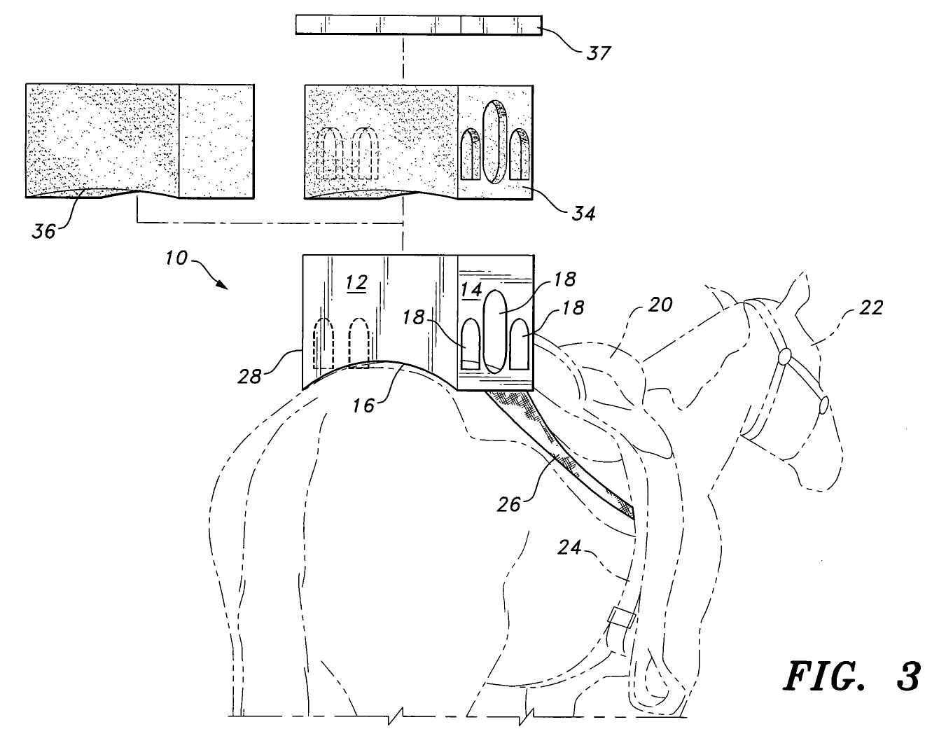

FIG. 3 is a perspective view of the carrier device for saddles 10 showing a first insert 34 that slides completely into the carrier device 10 and is sized to accommodate smaller dogs. The first insert 34 has holes defined therein having substantially the same dimensions and configuration as the ports 18 defined in front wall 14 and rear wall 28 in order to align therewith when insert 34 is seated within the carrier device 10. A second insert 36 slides completely into the first insert 34 and may be used to carry items that will not fit into a traditional saddlebag, such as food items or beverage containers. A lid 37 may be attached to the carrier device when carrying such items. The inserts may be made of rigid foam-like material with a soft interior.

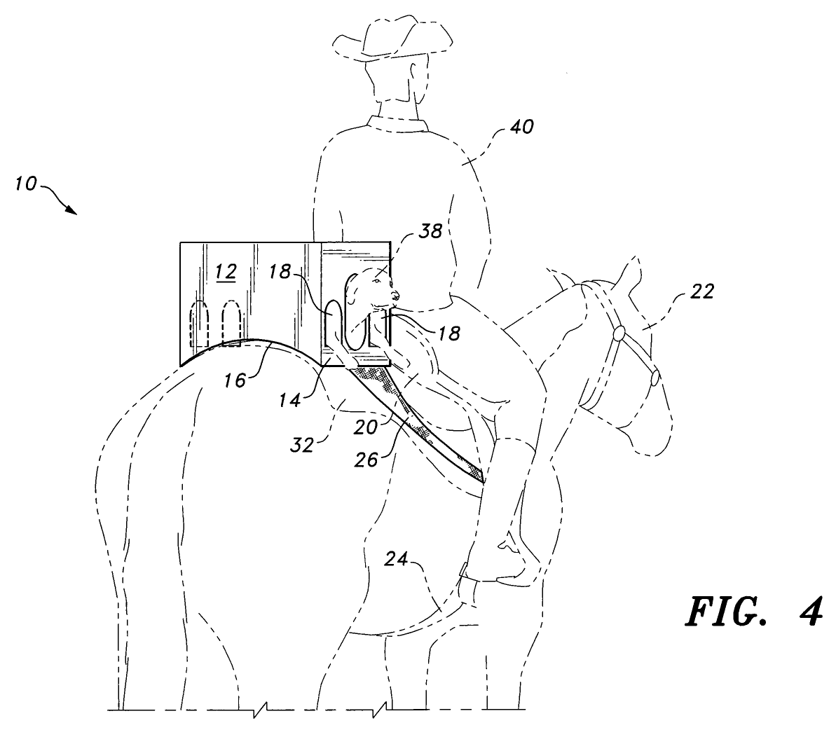

FIG. 4 is a perspective view of the carrier device for saddles 10 in use with a horse 22, rider 40 and dog 38 all shown in phantom. As FIG. 4 illustrates, the head and legs of the dog 38 extend out through the ports 18 on the front wall 14 of the carrier device 10.

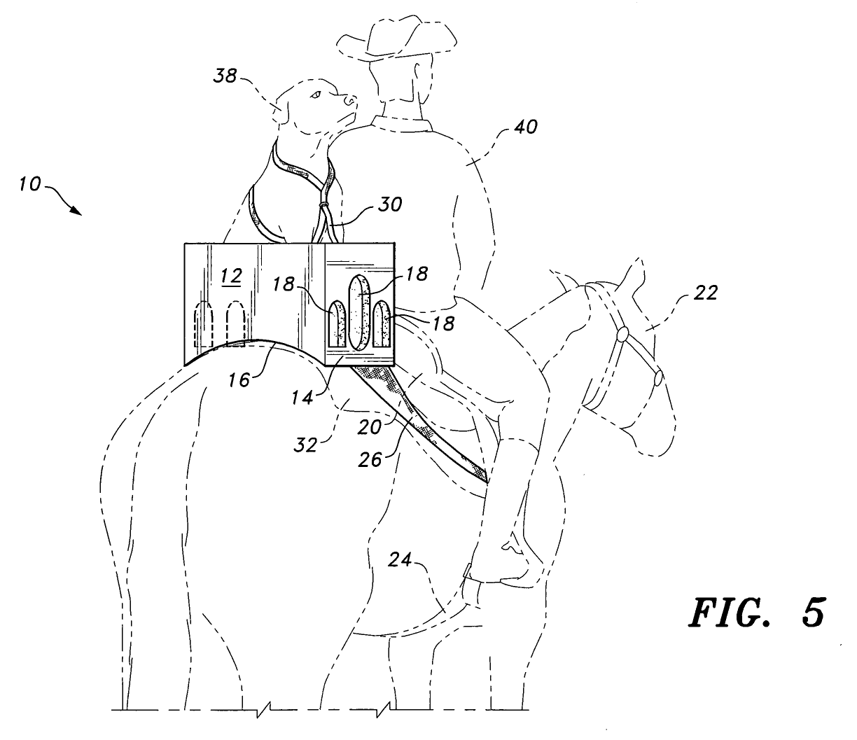

FIG. 5 is a perspective view of the carrier device for saddles 10, illustrating an alternative method for transporting a dog 38. The dog 38, horse 22 and rider 40 are shown in phantom. The dog 38 is seated in an upright position inside the carrier device for saddles 10 secured by the harness 30.

It is to be understood that the present invention is not limited to the embodiments described above, but encompasses any and all embodiments within the scope of the following claims.

I claim:

1. A carrier device for saddles, comprising:
a rectangular box having a front wall, a rear wall, opposing sidewalls, a bottom wall, and an open top, the front wall and the rear wall having a plurality of openings dimensioned and configured for passage of a dog's head and legs therethrough, the bottom wall being arched and adapted for placement across a horse's back; and
means for removably attaching the rectangular box to a horse saddle.

2. The carrier device for saddles according to claim 1, wherein the means for removably securing the carrier device to a horse saddle comprises connector straps extending from the bottom wall of said rectangular box, the connector straps being adapted for removably fastening the carrier device to a saddle girth.

3. The carrier device for saddles according to claim 1, further comprising a first insert frictionally slidable completely through the open top of the rectangular box, the first insert having a front wall, a rear wall, opposing sidewalls extending between the front wall and the rear wall, and a bottom wall, the front and rear walls of the insert having a plurality of openings having dimensions and configurations substantially identical to the openings formed in the front and rear walls of said rectangular box for passage of the dog's head and legs therethrough.

4. The carrier device for saddles according to claim 1, further comprising a second insert slidable into the first insert, the second insert portion having a front wall, a rear wall, opposing sidewalls, a bottom wall, and an open top.

5. The carrier device for saddles according to claim 1, wherein at least said bottom wall is made from flex tree material.
